(19) United States
(12) Patent Application Publication
(10) Pub. No.: US 2008/0086453 A1
(43) Pub. Date: Apr. 10, 2008

(54) Method and apparatus for correlating the results of a computer network text search with relevant multimedia files

(75) Inventor: Rhonda Fabian, Rose Valley, PA (US)

Correspondence Address: ROBERT S. LIPTON, ESQUIRE, 201 NORTH JACKSON STREET, P. O. BOX 934, MEDIA, PA, 19063-0934, US

(73) Assignee: Fabian-Baber, Inc., Springfield, PA (US)

(21) Appl. No.: 11/543,558

(22) Filed: Oct. 5, 2006

(51) Int. Cl. G06F 17/30

(52) U.S. Cl. 707/3

(57) ABSTRACT

The Invention is a method and apparatus for automatic retrieval, organization, correlation and presentation of text, image, audio, or video data in a sequential manner. A user searches a database available on a computer network using a text search engine to locate a text document. The text document is automatically read and parsed to identify text portions and key phrases. The key phrases are used to automatically search a multimedia file database available on the computer network using a multimedia search engine, such as an image search engine. Multimedia documents containing multimedia files are retrieved. Text in the multimedia documents is compared to the key terms and to the query terms and the multimedia documents are ranked by relevance using a variety of techniques including ranking, indexing, statistical analysis and natural language processing. Each text portion in the text document is stored in association with the most relevant multimedia file for that text portion. The resulting correlated information is displayed to the user in a sequence of text, audio, image or video data.

### BACKGROUND

A. Field of the Invention

The Invention is a method and apparatus for automatically locating a text document that is relevant to a predetermined topic, automatically locating multimedia files that are relevant to the text document, and correlating the text document with the multimedia files as a real-time presentation, where the text document and the multimedia files are located by searching databases over an Internet or other computer network. The Invention allows searching an existing database over a computer network to locate a text document coupled with automatically searching for and locating multimedia files relevant to the text of the text document. The text and most relevant multimedia files are organized and displayed or played to the user in a sequential, report-like format via any Internet or network connected computing device such as a desktop PC, PDA, mobile phone, video entertainment console and the like. The Invention may use speech synthesis to read the text to the user while displaying or playing the relevant multimedia files.

Terms used in this document are defined in the Description of an Embodiment section, supra.

B. Description of the Related Art

Both text and multimedia file searching are familiar to users of the Internet or other computer networks. Google is an example of a general-purpose text search engine. Google Image Search is an example of a conventional multimedia search engine. The prior art does not teach the method or apparatus of the Invention.

### BRIEF DESCRIPTION OF THE INVENTION

The Invention is a method and apparatus for automatically illustrating the results of a computer network text search with relevant multimedia files comprising images, text, audio and video data, also derived from the computer network. The method of the Invention involves conducting a search of a database over a computer network by inputting a query term into a conventional text search engine. A text document returned as a result of the text search is divided into text portions that are then parsed to derive key terms. The key terms are used as the search parameters for a search of multimedia databases over a computer network using a conventional multimedia search engine.

The multimedia search returns a plurality of multimedia files, such as image, audio and video files. Each multimedia file located by the multimedia search engine is contained within a multimedia document and each multimedia document contains multimedia document text. The multimedia document text is analyzed to determine the relevance of the multimedia document text to the query term or the key term. The returned multimedia documents are ranked by relevance of the multimedia document text. The top-ranked multimedia document is selected. The multimedia file associated with the top-ranked multimedia document is selected as the top-ranked multimedia file. The URL of the top-ranked multimedia file is stored in association with the text portion of the text document containing the key term used to locate the multimedia file.

The apparatus of the Invention simultaneously communicates the text document and the top-ranked multimedia files to the user. The multimedia files may be organized in a slide show format or in any other suitable format for display. The apparatus of the Invention may use conventional speech synthesis to read the text document to the user while displaying or playing the top-ranked multimedia file to the user.

The step of parsing the text document to extract key terms involves identifying text portions within the text document. A “text portion” is each sentence, phrase or group of associated words delineated by punctuation or by emphasizing HTML, as hereinafter defined. For each text portion, key terms are extracted using conventional techniques. The phrase “key term” means each proper noun and each noun or noun phrase.

The step of using each key term as a search parameter for a multimedia search involves automatically inputting each key term into a conventional multimedia search engine and searching a computer database. Where the computer network searched is the entire Internet, the number of multimedia documents returned as a result of the multimedia search is likely to be large and many multimedia documents will be returned that are of little relevance to the query term or to a key term. Computational ranking techniques are used to determine whether the multimedia files returned in the multimedia search are relevant to the key term and the query term. As an example of a technique to determine relevancy of multimedia files, the text of the multimedia documents containing the multimedia files may be filtered to eliminate multimedia documents (and hence multimedia files) unlikely to be relevant to the query term or the key term. A variety of filters may be employed to eliminate multimedia documents, and hence multimedia files, unlikely to be relevant. To rank the multimedia documents that survive the filtering step, frequent itemsets (as defined below) may be identified and the most frequently occurring word sequences of the frequent itemset identified. The multimedia documents may be ranked based on the occurrence of the frequent itemsets. Different weights may be assigned to different types of itemsets and the weighted values used to determine the relevancy of a multimedia document having the greatest weighted occurrence of the frequent itemsets. The multimedia document having the greatest weighted occurrence of frequent itemsets is selected as the multimedia document most relevant to the text segment of the text document. The URL or other location identifier of the multimedia file associated with the selected multimedia document is associated with the text portion of the text document and stored for display of the multimedia file to the user.

A variety of techniques may be combined to evaluate the multimedia document text and to rank multimedia documents by relevance to the text document. The different techniques may be applied separately or simultaneously. For example, the number of occurrences of the query term between Meta HTML tags of the multimedia document may be counted, along with the number of occurrences of the query term in the text of the multimedia document and the number of occurrences of the query term or the key term within the multimedia file's URL. Different weights can be assigned to the different techniques and the weighted numbers totaled to determine a total relevance score. The multimedia documents are then ranked by the relevance score and the top-ranked multimedia document selected.

Once a multimedia file is selected for each of the text segments of the text document, each multimedia file is organized and displayed simultaneously with the corresponding text portion of the text document to the user in a report-like, sequential multimedia presentation on the user's browsing device.

### BRIEF DESCRIPTION OF THE FIGURES

FIG. 1 is a schematic diagram of the apparatus of the Invention.

FIG. 2 is a flow chart of the method of the Invention.

FIG. 3 is a flowchart of the method of extracting key terms from a text document.

FIG. 4 is a flow chart of a first method of determining relevance of a multimedia document to a text document.

FIG. 5 is a flow chart of the multimedia document filtering step of the first method.

FIG. 6 is a flow chart of the segment filtering step of the first method.

FIG. 7 is a flow chart of a second method of determining relevance of a multimedia document to a text document.

FIG. 8 is a flow chart of a third method of determining relevance of a multimedia document to a text document.

FIG. 9 is a flow chart of a fourth method of determining relevance of a multimedia document to a text document.

### DESCRIPTION OF AN EMBODIMENT

### A. Definitions:

As used in this document, the following words have the following meanings. Defined terms are italicized in the Description of an Embodiment.

1. Browsing Device—means any Internet or computer network-connected computer device capable of displaying text, images, audio, or video data including, but not limited to, desktop personal computers, personal data assistants, tablet computers, mobile phones, handheld gaming or multimedia devices, television set-top gaming or entertainment devices, telephones, or any other suitable device.

2. Confidence level—means the degree of certainty that a selected multimedia file will be relevant to the query term.

3. Cue-phrase—means phrases that connect discourse spans and add structure to the discourse both in text and dialogue. Cue-phrases signal a topic shift and change in attention status. Examples of cue-phrases include “first,” “and” and “now.”

4. Emphasizing HTML—means HTML tags used in web pages to set apart a word or phrase and to emphasize that word or phrase. Emphasizing HTML tags indicate whether the word is bolded, in italics, is a heading and the like. Examples include <b>, <strong>, <i>, <em>, <h1>, and <h2>.

5. Emphasizing punctuation—means a colon, semi-colon, dashes, parentheses or quotes.

6. Frequent itemset—means an itemset that occurs in at least a predetermined number of multimedia documents. The number of occurrences to qualify the itemset as “frequent” is determined to provide a selected confidence level to the result.

7. Hash table—means a Lookup table for storing non-sequential “key-value pairs.” The “key” is an identifier, such as an account number. The “value” is the data, such as account transactions, identified by the “key.” The “key-value pairs” are allocated among “buckets” by a “hashing algorithm” so that the “buckets” are filled evenly. To determine the frequency of occurrence of specific word orders of an itemset, each occurrence of the itemset may be lexicographically sorted into a Hash table.

8. Itemset—means groups of words that occur together in one or more multimedia documents. Itemsets are not specific as to the sequence of words in the itemset; for example, the itemset “Ace Butter Car” is the same as “Butter Car Ace.”

9. Key term—means the terms extracted from the text document returned by the text search and that will be used as a search parameter for the multimedia file search.

10. Lexicographically sort—means to list all permutations of word sequences in an itemset, such as “Ace Butter Car,” “Ace Car Butter,” “Butter Ace Car,” “Butter Car Ace,” “Car Ace Butter” and “Car Butter Ace.”

11. Meta HTML tags—means text included on a web page that is about the page and is intended to be read and applied by machines rather than by people.

12. Multimedia document—means a web page located by a multimedia search engine (such as Google Image Search) that contains or is linked to a multimedia file.

13. Multimedia document text—means text contained within a multimedia document. Multimedia document text is analyzed according to the method of the Invention to determine the relevance of the associated multimedia file.

14. Multimedia file—means an electronic file comprising an image, video or audio information, or any combination of image, video and audio information.

15. Multimedia file search—means a search of a database accessible to a computer network for a multimedia file using a multimedia file search engine. An example of a multimedia file search engine is Google Image Search.

16. Narrowing words—means words contained within a multimedia document that indicate that the multimedia document likely relates to only a single topic. Narrowing words are determined empirically. The words “definition,” “about,” and “article” are narrowing words.

17. Noise—means, with respect to a multimedia document, the occurrence of non-relevant text within the multimedia document.

18. Query Phrase/key Phrase Incidence Criterion—means a filter applied to a multimedia document text to eliminate a multimedia document in which the incidence of a query term or of a key term does not meet a required minimum; for example, six incidences of a key term or of a query term within a single page of the multimedia document.

19. Query term—means a word or series of words initially entered into a text search engine to locate text documents relating to the query term. An example of a general purpose text search engine is Google.

20. Segment—as applied to a text document means both text appearing between HTML tags and text delineated by emphasizing punctuation.

21. Set of filtered multimedia documents—means the multimedia documents remaining after a multimedia file search and after filtering of the multimedia documents.

22. Stop words—means words that occur too frequently in a document and hence have little informational meaning.

23. Text document—means a web page retrieved by a text search engine, such as Google, preferably from a topic database such as Wikipedia, in response to a user query using a query term. A text document may include within the document elements in addition to text, such as images, audio or video.

24. Text line—means a single line of text appearing within a multimedia document.

25. Text portion—means each sentence, phrase or group of associated words within a text document delineated by punctuation or by emphasizing HTML.

26. Thumbnail image—means the small JPEG image generated by a web browser to represent or a multimedia file.

27. Top-ranked—a. when referring to a multimedia file, a multimedia document or multimedia document text, the term top-ranked means the multimedia file, multimedia document or multimedia document text with the highest determined degree of relevance to the text document. The top-ranked multimedia file is defined by the top-ranked multimedia document text and hence the top-ranked multimedia document. The top-ranked multimedia file is associated with the text document and displayed to the user along with the text document.
b. When referring to a frequent itemset, the term top-ranked means the frequent itemset having the greatest occurrence within the universe of retrieved multimedia documents.

28. Transactional set—means a data set of text segments that survive after multimedia documents are subject to filtering.

29. Word sequence—means, as applied to an itemset, a specific order of words appearing in the itemset. A word sequence of ace, butter, car is not the same as the word sequence car, butter, ace.

30. Word stemming—means removing the suffix from a word to determine the root of the word.

### B. Apparatus and Method of the Invention

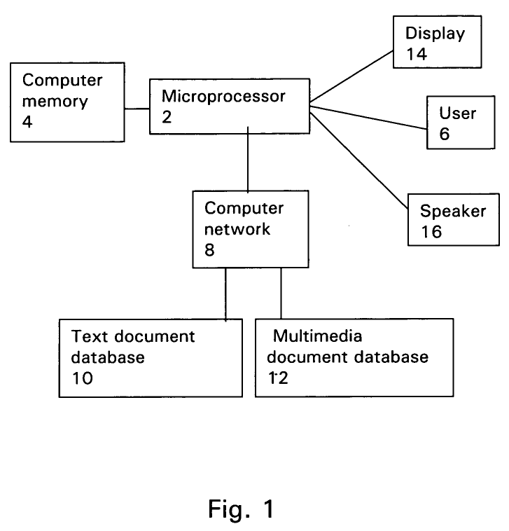

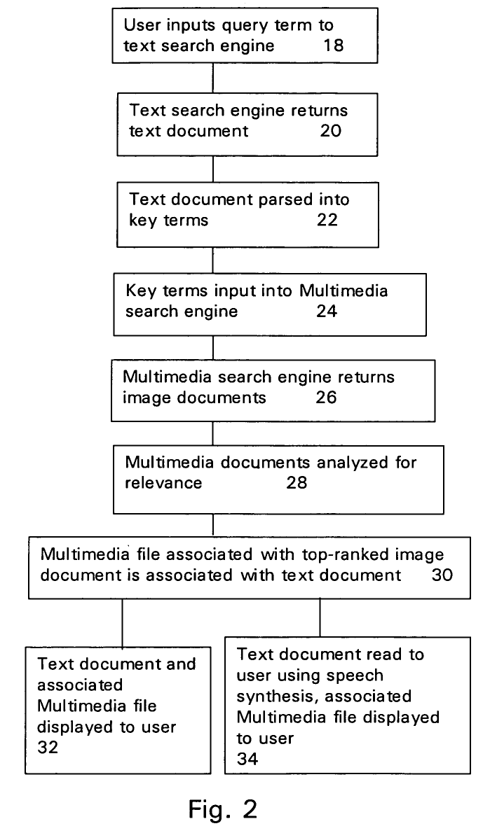

FIG. 1 illustrates the apparatus of the Invention. FIG. 2 is a flow chart illustrating the method of the invention. From FIG. 1, the apparatus of the Invention includes software running on a microprocessor 2 and associated computer memory 4. Microprocessor 2 receives commands from user 6. Microprocessor 2 is connected to a computer network 8 which may be the Internet or other public or private computer network. The computer network 8 is connected to text database 10 and to a multimedia file database 12, which may be the same database. Text database 10 contains a multiplicity of text documents. Multimedia file database 12 contains a multiplicity of multimedia files and associated multimedia documents.

The text database 10, preferably is limited to sources of known quality to avoid excessive irrelevant results. Examples of suitable databases are the Wikipedia, Encyclopedia Britannica and Encarta Internet web sites. Any suitable web site or database may be the subject of the method and apparatus of the Invention, such as a corporate database on a local area network.

As shown by the method illustrated by FIG. 2 at element 18, the microprocessor 2 is programmed to receive a query term from user 6 and to conduct a text search of the text database 10 using the query term parameter. The microprocessor 2 is programmed to apply a conventional text search engine to conduct the text search.

From element 20 of FIG. 2, the microprocessor 2 is further programmed to receive text documents as the result of the text search. The text search will identify text documents that contain the query term.

From element 22, the microprocessor 2 automatically divides the text document into text portions and extracts key terms from the text portions. The microprocessor 2 is programmed to then conduct automatically a multimedia file search of the multimedia file database 12 using the key terms as multimedia file search parameters, from element 24. The microprocessor 2 is programmed to apply a conventional multimedia file search engine to conduct the multimedia file search and is programmed to receive a plurality of thumbnail images corresponding to multimedia documents as a result of the multimedia file search, as shown by element 26. Each of the multimedia documents has an associated multimedia file and an associated multimedia document text.

From element 28, microprocessor 2 automatically analyzes the multimedia document text to infer whether the multimedia file associated with the multimedia document is relevant to the text document located in the text search. The microprocessor 2 selects the most relevant multimedia document, from element 30. The microprocessor 2 is programmed to associate the text portion of the text document with the multimedia file corresponding to the most relevant multimedia document. The microprocessor 2 is programmed to display the text portion of the text document to the user 6 and to illustrate the text portion of the text document by simultaneously displaying the most relevant multimedia files to the user 6 on computer display 14, as shown by element 32 of FIG. 2.

The microprocessor 2 may be programmed to read the text document to the user 6 utilizing conventional speech synthesis technology and a speaker 16, as shown by element 34 of FIG. 2. The microprocessor 2 is programmed to simultaneously exhibit the multimedia files or thumbnail image to the user 6 utilizing computer display 14.

### C. Parsing a Text Document into Key Terms

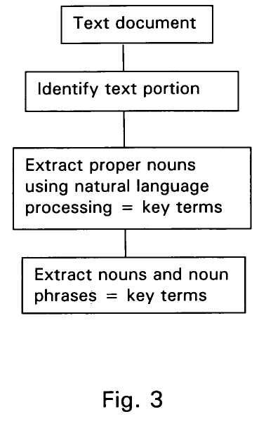

FIG. 3 is a flow chart showing how the microprocessor 2 implements element 22 of FIG. 2; namely, the step of parsing text portions identified within a text document into key terms. From FIG. 3, the microprocessor 2 starts with a text document received by the microprocessor 2 as a result of the text search. The microprocessor 2 identifies text portions of the text document and applies text analysis techniques including conventional natural language processing to extract key terms comprising nouns, proper nouns, and noun phrases from the text portions. As shown by element 24 of FIG. 2, the key terms are automatically input into a multimedia file search engine by the microprocessor 2 and used to conduct a multimedia file search for each key term.

### D. First Method for Determining Relevance of Multimedia Documents

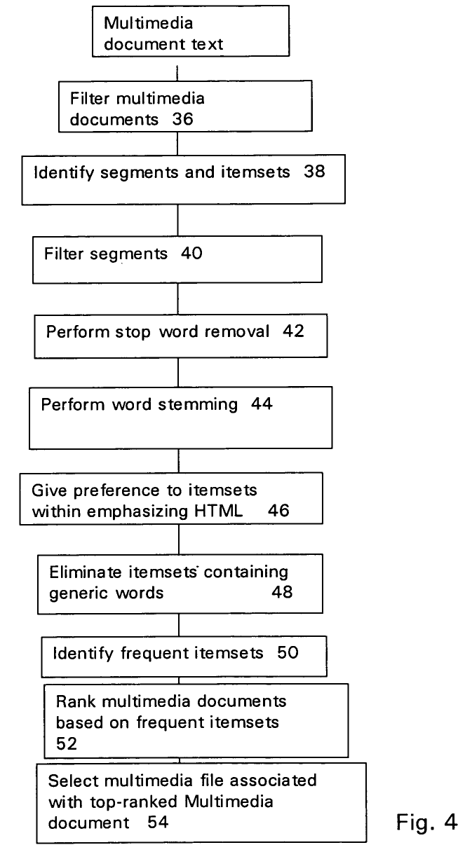

FIG. 4 is a flow chart showing a first method by which the microprocessor 2 implements element 28 of FIG. 2; namely, analyzing multimedia documents for relevance to the text document. From FIG. 4, the method of analyzing multimedia document starts with the multimedia document text. The microprocessor 2 filters the multimedia documents to eliminate excessively noisy multimedia documents (and hence to eliminate the multimedia file associated with the multimedia document), as shown by element 36 of FIG. 4. Excessively noisy multimedia documents are those documents containing terms that do not corresponding the original query term.

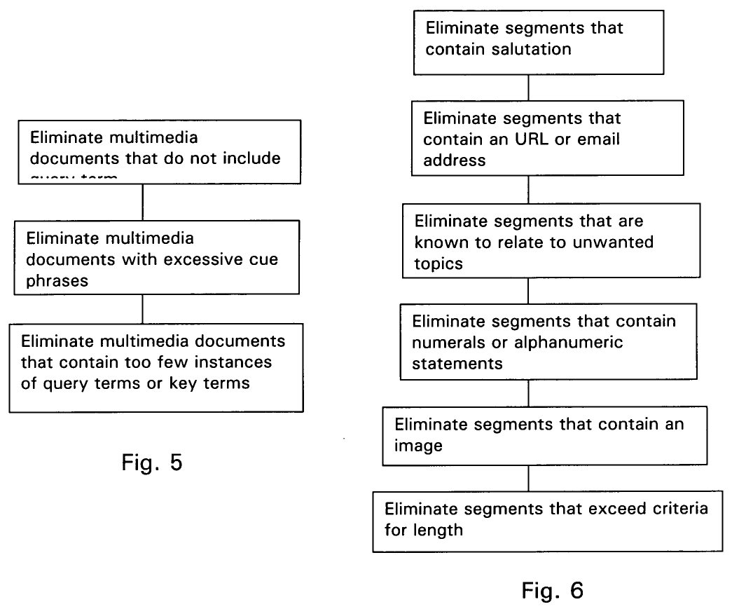

FIG. 5 is a flowchart of element 36, the multimedia document filtering step. From FIG. 5, the multimedia document text of the multimedia document is examined and multimedia documents eliminated that do not include all of the words in the query term used in the original topic search. The microprocessor 2 looks for cue-phrases (as defined above) within the multimedia document text and eliminates multimedia documents that have a number of cue-phrases that exceed a pre-determined criterion. The microprocessor 2 counts the occurrences of query terms or key terms in the multimedia document text. If the number of occurrences does not meet a pre-determined query phrase/key phrase incidence criterion, the multimedia document is eliminated. The multimedia documents remaining after the filtering step is the set of filtered multimedia documents.

From step 38 of FIG. 4 and for each multimedia document in the set of filtered multimedia documents, the microprocessor 2 identifies all segments. As noted above, a “segment” is denoted by HTML tags or by emphasizing punctuation. The microprocessor 2 will look for HTML tags or emphasizing punctuation and will identify each segment.

FIG. 6 is a flow chart of element 40 of FIG. 4, the filtering of segments. The microprocessor 2 will use multiple techniques to determine if a segment within an image document has no utility in determining image document relevancy, including, but not limited to, determining if the segment contains an URL address or email address, relates to unwanted topics, contains excessive numerals or unwanted symbols, or exceeds a predetermined criterion for length.

As shown by element 42 of FIG. 4, the microprocessor 2 will remove ‘stop words’ from the itemsets. Stop words are words that appear so commonly in the document as to convey little meaning. The itemsets are reviewed for the occurrence of words and words that appear with a frequency exceeding a predetermined criterion are eliminated from the itemsets. As shown by element 44 of FIG. 4, the microprocessor 2 also performs word stemming on each itemset. Some words may be converted to the root of the word to assist in comparing words, itemsets and multimedia documents one to another.

As defined above, the words in each segment define an “itemset.” As shown by element 48 of FIG. 4, the microprocessor 2 will identify itemsets that appear alone as emphasized text within any multimedia document. An itemset is emphasized if it appears within Emphasizing HTML. Itemsets that appear alone as emphasized text are given greater weight than itemsets that do not appear alone as emphasized text.

As shown by element 48 of FIG. 4, the microprocessor 2 will eliminate itemsets that only contain generic words. The list of generic words is determined empirically and contains words used frequently on the Internet.

In elements 50 and 52, the microprocessor 2 evaluates the remaining itemsets to determine frequent itemsets, as defined above. The microprocessor 2 ranks the frequent itemsets by the frequency of occurrence within the universe of identified multimedia documents of each possible word sequence in the itemset. The frequency of occurrence of each word sequence of the itemset within the universe of the located multimedia documents may be determined through conventional means by a lexicographical sort of all occurrences of the itemset into a hash table using a hashing algorithm.

The highest-ranking frequent itemsets are likely to be relevant to the query term and to the key term. The multimedia document from which the highest-ranking frequent itemset was derived is the highest-ranking multimedia document. The URL location of the multimedia file associated with the text segment of the multimedia document in which the highest-ranking frequent itemset is located will be stored to illustrate the text segment of the text document in which the key term is located, indicated by element 54 of FIG. 4.

The microprocessor 2 selects the top-ranked multimedia document and stores the URL of the multimedia file associated with the top-ranked multimedia document. The microprocessor 2 associates that multimedia file URL with the text portion containing the key term extracted from the text document. The microprocessor 2 automatically generates a sequence of text from the text document along with multimedia files associated with that sequence of text. The microprocessor 2 displays the text and associated multimedia files or thumbnail images to a user 6 in sequence on the browsing device 14. Depending on the options selected by the user 6 and depending on hardware limitations of the browsing device utilized by the user 6, the microprocessor 2 may convert the text from the text document into speech and play the speech to the user 6 over speaker 16 while the associated multimedia files or thumbnail images are shown on display 14.

### E. Second Method for Determining Relevancy of Multimedia Documents

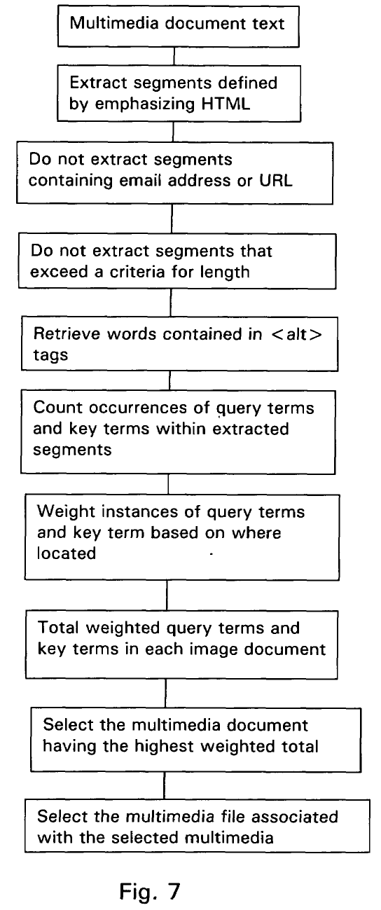

FIG. 7 illustrates a second method for determining the relevancy of a multimedia file associated with a multimedia document returned as the result of a multimedia file search. FIG. 7 addresses element 28 of FIG. 2.

The method illustrated by FIG. 7 starts with the multimedia document text returned by a multimedia file search as described above relating to FIG. 2. The microprocessor 2 extracts segments defined by emphasizing HTML. The microprocessor 2 may ignore segments that are likely to be useless, such as those that contain an email address or an URL or that exceed a pre-determined criterion for length of the segment. The microprocessor 2 will also retrieve multimedia file URLs from any <img> tags (indicating an image file) and will retrieve text contained within <alt> tags (indicating a description) and check for key terms existing within these retrieved items in order to rank the multimedia documents and hence the multimedia files accordingly.

The microprocessor 2 will rank the multimedia document according to how many occurrences of the query term and a key term appear in the multimedia document and where those terms appear in the document. For example, extra weight may be given to key terms or query terms appearing between Meta HTML tags (<meta>), in a header tag (<h1>), or in description of the multimedia file (<alt>). The microprocessor 2 will select the top-ranked multimedia document and will store the URL of the multimedia file associated with the top-ranked multimedia document. The microprocessor will associate the multimedia file with the text portion of the text document_containing the corresponding key term. The microprocessor 2 will communicate the text document and the multimedia files or thumbnail images associated with the text document to the user 6, as described above.

### F. Third Method for Determining Relevancy of Multimedia Documents

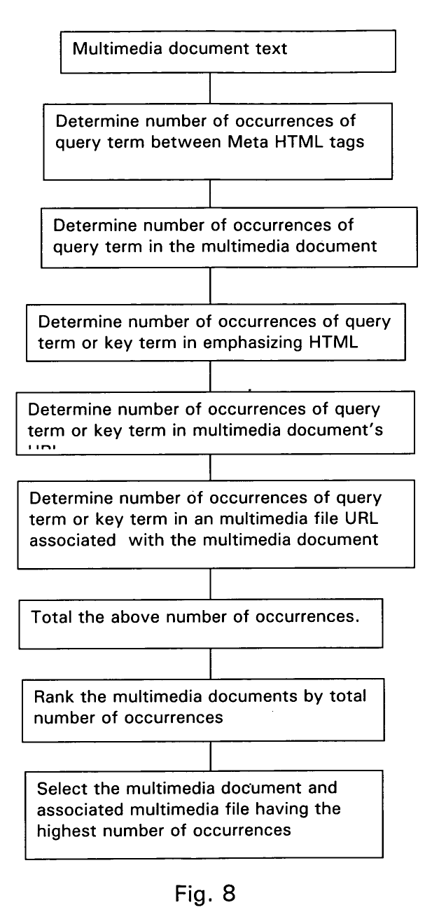

FIG. 8 illustrates a third method for determining the relevancy of a multimedia file associated with a multimedia document returned as the result of a multimedia file search. FIG. 8 also addresses element 28 of FIG. 2.

As illustrated by FIG. 8, starting with a multimedia document retrieved as a result of a multimedia file search, the microprocessor 2 will determine several metrics relating to the multimedia document text. The metrics will be used to determine a relevance score of the multimedia document. The multimedia document having the greatest relevance score will be selected.

From FIG. 8, the microprocessor 2 will parse the multimedia document text and will determine the following: the number of occurrences of the query term between Meta HTML tags of the multimedia document; the number of occurrences of the query term in the text of the multimedia document; the number of occurrences of either the query term or the key term within emphasizing HTML of the multimedia document; the number of occurrences of either the query term or the key term within the multimedia document's URL; and the number of occurrences of the query term or the key term within the multimedia file's URL.

The microprocessor 2 will sum the metrics calculated in the preceding paragraph to obtain a relevance score for the multimedia document. The document with the highest relevance score is the top-ranked multimedia document. The microprocessor 2 will select the top-ranked multimedia document and store the URL of the multimedia file associated with the top-ranked multimedia document. The microprocessor 2 will associate that multimedia file URL with the text portion of the text document from which the key term was extracted.

The microprocessor 2 will communicate the text document and the multimedia files or thumbnail images associated with the text document to the user 6, as described above.

### G. Fourth Method for Determining Relevancy of Multimedia Documents

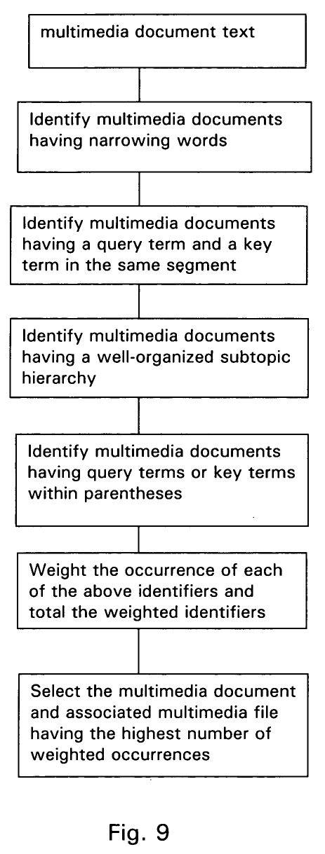

FIG. 9 illustrates a fourth method for determining the relevancy of a multimedia file associated with a multimedia document returned as the result of a multimedia file search. FIG. 9 addresses element 28 of FIG. 2. In the fourth method, the microprocessor 2 looks for and identifies query terms or key terms in a number of locations in each multimedia document and assigns weights to the various locations within the multimedia document where the query term or key term is located. The weighted occurrences of the query terms and key terms are totaled and compared to the totals for other multimedia documents.

As shown by FIG. 9 and starting from the multimedia document text of a multimedia document identified as a result of a multimedia file search, the microprocessor 2 Identifies multimedia documents that include narrowing words, such as “definition,” “about,” “article” and other words empirically determined to indicate that the multimedia document is devoted to a single topic. Multimedia documents devoted to a single topic are more likely to be relevant than those that are not.

Also as shown by FIG. 9, the microprocessor 2 will identify multimedia documents that include both the query term and a key term within the same segment. The microprocessor 2 will count each such occurrence.

The microprocessor 2 will identify multimedia documents that include a well-organized subtopic hierarchy and will identify those well-organized multimedia documents that include a key term in a subtopic of a query term topic. Such multimedia documents and associated multimedia files are likely to be relevant to both the query term and to the key term. Well-organized subtopic hierarchies may be identified using conventional techniques through HTML nested list items.

The microprocessor 2 will identify multimedia documents including query terms or key terms enclosed in parentheses (“( )”). As used in Internet documents, parentheses are often used to enclose important concepts in a document.

The microprocessor 2 will weight each of the above factors relating to FIG. 9. For example, the existence of a key term in a subtopic of a query term topic in a multimedia document with well-organized subtopic hierarchies may be entitled to more weight than the presence of narrowing words in an multimedia document. The microprocessor 2 will total the weighted factors to determine a relevance score for the multimedia document.

The microprocessor 2 will rank the multimedia documents by the relevance score and select the top-ranked multimedia document. The microprocessor 2 will associate the multimedia file URL of the top-ranked multimedia document with the text portion of the text document in which the key term appears. The microprocessor 2 will communicate the text document and the multimedia files or thumbnail images associated with the text document to the user 6, as described above.

The various techniques of the first through fourth methods of determining relevance of the multimedia documents may be blended or substituted one for another to achieve the best results, as determined empirically. More than one method may be employed at the same time and the results compared as needed to achieve a desired confidence level. If separate analyses using different techniques agree on the relevance of a particular multimedia document, that multimedia document is likely to be relevant.

Where a multimedia document returned by a multimedia search contains more than one multimedia file, the Meta data such as the <alt> property of the <img> tag as well as the multimedia file's file name is examined to determine relevancy. The most relevant of the multimedia files is associated with the text portion for communication to the user.

In describing the above embodiments of the invention, specific terminology and simplification of data was selected for the sake of clarity and brevity. However, the invention is not intended to be limited to the specific terms so selected, and it is to be understood that each specific term includes all technical equivalents that operate in a similar manner to accomplish a similar purpose.

I claim:

1. A method for locating a text document and automatically illustrating the text document with a multimedia file using a computer network, the method comprising the steps of:
a. receiving a query term from a user;
b. conducting a search of the computer network for the text document utilizing said query term;
c. retrieving the text document from the computer network;
d. automatically parsing the text document into a plurality of key terms;
e. automatically conducting a multimedia file search on the computer network utilizing said plurality of key terms;
f. locating the multimedia file on the computer network as a result of said multimedia file search;
g. automatically associating the multimedia file and the text document;
h. communicating the text document to said user and displaying the associated multimedia file to said user contemporaneously.

2. The method of claim 1 wherein the multimedia file is a selected one of a plurality of multimedia files, said step of locating the multimedia file further comprising:
a. locating automatically said plurality of multimedia files in said multimedia file search;
b. ranking automatically each of said plurality of multimedia files by relevancy to said query term and to said one of said plurality of key terms;
c. identifying automatically a top-ranked multimedia file of said ranked plurality of multimedia files, said top-ranked multimedia file defining said selected one of said plurality of multimedia files.

3. The method of claim 2 wherein each of said plurality of multimedia files is associated within the computer database with a one of a plurality of multimedia documents, said step of ranking automatically said plurality of said multimedia files comprising:
a. ranking each of said plurality of multimedia documents for relevancy to said query term and to said one of said plurality of said key terms;
b. identifying a top-ranked multimedia document from among said plurality of multimedia documents, said top-ranked multimedia file being said one of said plurality of multimedia files associated with said top-ranked multimedia document.

4. The method of claim 3 wherein said step of automatically parsing the text document into said plurality of key terms comprises: identifying a plurality of text portions of said text document; parsing each of said plurality of text portions to identify a plurality of nouns, proper nouns or noun phrases, each of said plurality of said nouns, said proper nouns and said noun phrases defining a one of said plurality of key terms.

5. The method of claim 4 wherein said step of automatically associating the multimedia file and the text document and said step of communicating the text document to said user comprising:
a. connecting operably said selected multimedia file with a one of said plurality of text portions in which said key term appears;
b. displaying said one of said plurality of said text portions to said user and contemporaneously displaying said selected multimedia file to said user.

6. A method for locating a text document and automatically illustrating the text document with a multimedia file using a computer network, the method comprising the steps of:
a. receiving a query term from a user;
b. conducting a search of the computer network for the text document utilizing said query term;
c. locating the text document on the computer network;
d. automatically parsing the text document into a plurality of key terms;
e. automatically conducting a multimedia file search on the computer network utilizing a one of said plurality of key terms;
f. automatically locating a plurality of the multimedia files as a result of said multimedia file search, each of said plurality of multimedia files being associated with a one of a plurality of multimedia documents, each of said plurality of multimedia documents including a multimedia document text;
g. automatically analyzing said multimedia document text contained within each of said plurality of multimedia documents to determine a degree of relevance of each of said plurality of multimedia documents to said query term and to said one of said plurality of key terms;
h. automatically ranking each of said plurality of said multimedia documents by said degree of relevance;
i. automatically selecting a top-ranked multimedia document from said ranked plurality of said multimedia documents;
j. automatically selecting the multimedia file associated with said top-ranked multimedia document to define a selected multimedia file;
k. automatically associating said selected multimedia file and the text document;
l. communicating the text document and said selected multimedia file to said user contemporaneously.

7. The method of claim 6 wherein the text document has a text and defines a text portion, said text portion containing said one of said plurality of key terms, said step of automatically associating said selected multimedia file with the text document comprising: operably connecting said selected multimedia file with said text portion of the text document.

8. The method of claim 7, said step of analyzing said multimedia document text contained within each of said plurality of multimedia documents comprising: filtering said plurality of said multimedia documents and eliminating those of said plurality of multimedia documents that exhibit noise greater than a noise predetermined criterion.

9. The method of claim 8, said step of filtering said plurality of said multimedia documents comprising: eliminating each of said plurality of said multimedia documents that does not include each said query term.

10. The method of claim 8, said step of filtering said plurality of said multimedia documents comprising: eliminating each of said plurality of said multimedia documents in which an occurrence of a cue-phrase exceeds a cue-phrase predetermined criterion.

11. The method of claim 8, said step of filtering said plurality of said multimedia documents comprising: eliminating each of said plurality of said multimedia documents in which an incidence of said query term or of said key phrase does not meet a query term/key phrase incidence criterion.

12. The method of claim 8, said step of analyzing said plurality of multimedia documents further comprising:
a. identifying a segment within said plurality of multimedia documents, said segment being defined by an html operator or by an emphasizing punctuation;
b. identifying a plurality of itemsets that exist within said segment of said text;
c. eliminating from said plurality of itemsets said itemsets that do not exist alone within emphasizing html appearing in said segment;
d. eliminating from said plurality of itemsets said itemsets that contain a generic word.

13. The method of claim 12, said step of analyzing said plurality of multimedia documents further comprising:
a. identifying a plurality of frequent itemsets from among said plurality of itemsets, each of said frequent itemsets having a word sequence;
b. determining a frequency of occurrence within said segment of said word sequence of each of said plurality of frequent itemsets;
c. ranking each of said plurality of frequent itemsets by said frequency of occurrence, said ranking defining a top-ranked frequent itemset based on said frequency of occurrence;
d. selecting said multimedia document in which said top-ranked frequent itemset appears, said multimedia document in which said top-ranked frequent itemset appears defining said top-ranked multimedia document.

14. The method of claim 6 wherein each of said plurality of said multimedia documents includes a plurality of a word or phrase within said multimedia document text, said step of analyzing said multimedia document text contained within each of said plurality of multimedia documents comprising:
a. reading said multimedia document text within each of said plurality of multimedia documents;
b. extracting from said multimedia document text each said word and each said phrase that exists within an emphasizing html segment.

15. The method of claim 14, said step of analyzing said multimedia document text further comprising:
a. extracting from said multimedia document text each said word and each said phrase appearing within a multimedia file description tag, said extracted words and said extracted phrases in combination defining an extracted word set for said multimedia document;
b. counting an occurrence of said query term or said key term within said extracted word set;
c. ranking each said multimedia document based on said occurrence of said query term or said key term within said extracted word set;
d. identifying a one of said multimedia documents having a greatest said occurrence of said query term or said key term within said extracted word set, said identified multimedia document defining said top-ranked multimedia document.

16. the method of claim 15, said step of ranking each said multimedia document based on said occurrence of said query term or said key term further comprising: weighting said occurrence of said query term or said key term based upon a location of said occurrence of said query term or said key term within said multimedia document, said step of weighting said occurrence of said query term or said key term comprising providing greater weight to said query term or to said key term that appears in said multimedia document within a Meta tag segment, within a header tag segment, or in a multimedia file description tag segment.

17. The method of claim 6, said step of automatically analyzing said multimedia document text comprising:
a. counting a number of occurrences of said query term or said key term within a segment of said multimedia document, said segment being defined by a text appearing between HTML tags or said text delineated by emphasizing punctuation;
b. ranking each of said plurality of said multimedia documents based upon said counted number of occurrences of said query term or said key term within said segment of each said multimedia document.

18. The method of claim 17, said step of automatically analyzing said multimedia document text further comprising:
a. counting a number of occurrences of said query term within said multimedia document text of each of said multimedia documents;
b. summing, for each said multimedia document text, said counted number of occurrences within said segment and said counted number of occurrences of said query term within said multimedia document text to determine a total number of occurrences, said step of ranking each of said plurality of multimedia documents comprising ranking each of said plurality of multimedia documents based on said total number of occurrences of said query term within said multimedia document text and said query term or said key term in said segment.

19. The method of claim 18 wherein said segment is selected from a list consisting of said segment defined by a Meta tag and said segment defined by an emphasizing HTML.

20. The method of claim 19 wherein said total number of occurrences further comprises a number of occurrences of either said query term or said key term within an URL associated with said multimedia document.

21. The method of claim 20 wherein said URL associated with said multimedia document is selected from a list consisting of a multimedia document URL and a multimedia file URL.

22. The method of claim 6, said step of analyzing said multimedia document text further comprising: identifying said multimedia documents that include a narrowing word.

23. The method of claim 6, said step of analyzing said multimedia document text further comprising: identifying said multimedia documents that include a well-organized subtopic hierarchy in which said query term is included within a query term topic and said key term is included within a subtopic of said query term topic.

24. The method of claim 6, said step of analyzing said multimedia document text further comprising: identifying multimedia documents including said query term or said key term within a pair of parenthesis symbols.

25. An apparatus for locating a text document within a computer network and illustrating the text document to a user with a multimedia file, the apparatus comprising:
a. a microprocessor, said microprocessor being configured to be connected to the computer network, said microprocessor being programmed to conduct a text search using a text search engine of a text database connected to the computer network, said microprocessor being programmed to apply a user-selected query term as a text search parameter in said text search;
b. said microprocessor being programmed to receive the text document as a result of said text search, the text document comprising a text, said microprocessor being further programmed to identify automatically a text portion of said text and to extract automatically a proper noun, a noun or a noun phrase from said text portion, said proper noun, said noun or said noun phrase defining a key term;
c. said microprocessor being programmed to conduct automatically a multimedia file search of a multimedia file database using a multimedia file search engine, said multimedia file database being available on the computer network, said microprocessor being programmed to use said key term as a multimedia file search parameter for said multimedia file search.
d. said microprocessor being programmed to receive automatically a plurality of multimedia documents as a result of said multimedia file search, each of said multimedia documents being associated with a multimedia file, each said multimedia document including an multimedia document text;
e. said microprocessor being programmed to rank automatically each said multimedia document based on a relevance of said multimedia document text included in each said multimedia document to said query term or to said key term;
f. said microprocessor being programmed to select automatically a one of said plurality of said multimedia documents based on said ranking;
g. said microprocessor being programmed to associate automatically said text portion and said multimedia file associated with said selected one of said plurality of multimedia documents;

26. The computer of claim 25 wherein said computer is programmed and configured to display said text portion of said text document and said selected multimedia file to said user simultaneously.

27. The computer of claim 26 wherein said microprocessor is programmed and configured to synthesize speech, said microprocessor being programmed to display said selected multimedia file and to read simultaneously said text document to said user using said speech synthesis.
